(19) United States
(12) Patent Application Publication
(10) Pub. No.: US 2006/0152611 A1
(43) Pub. Date: Jul. 13, 2006

(54) Image pickup device

(75) Inventors: Koujirou Yoneda, Osaka (JP); Toshiya Fujii, Shiga (JP); Takahiro Iwasawa, Kyoto (JP); Takumi Yamaguchi, Kyoto (JP)

Correspondence Address: HAMRE, SCHUMANN, MUELLER & LARSON, P.C., P.O. BOX 2902-0902, MINNEAPOLIS, MN, 55402, US

(73) Assignee: MATSUSHITA ELECTRIC INDUSTRIAL CO., LTD.,, Osaka (JP)

(21) Appl. No.: 10/534,892

(22) PCT Filed: Nov. 17, 2003
(86) PCT No.: PCT/JP03/14560

§ 371 Date: Oct. 13, 2005

(30) Foreign Application Priority Data
Nov. 15, 2002 (JP) 2002332855

(51) Int. Cl. H04N 5/335

(52) U.S. Cl. 348/308

(57) ABSTRACT

An imaging element includes a photoelectric conversion element, a readout transistor, an accumulated element, a detection transistor, and a reset transistor. The readout transistor reads a signal charge when a gate potential to be supplied to the gate terminal is changed from a first state to a second state. The detection transistor detects a voltage signal after the gate potential to be supplied to the gate terminal of the readout transistor is changed from the second state to the first state. A reset potential supplied from the reset transistor to the accumulated element has an intermediate potential between the gate potential in the first state that is supplied to the gate terminal of the readout transistor and a predetermined VDD potential.

### TECHNICAL FIELD

The present invention relates to an image pickup device including an imaging element composed of a NMOS transistor.

### BACKGROUND ART

A conventional image pickup device (see, e.g., JP 2002-237584 A) including an imaging element composed of a NMOS transistor will be described below. FIG. 11 is a block diagram showing the configuration of a conventional image pickup device 90. The image pickup device 90 includes an imaging element 7 for imaging a subject. The imaging element 7 includes a pixel portion 96. FIG. 12 is a schematic diagram showing the configuration of the pixel portion 96. The pixel portion 96 has a plurality of pixel units 99 arranged in a matrix form. FIG. 13 is a circuit diagram showing the configuration of each of the pixel units 99. A pixel unit 99 includes a photoelectric conversion element 4. The photoelectric conversion element 4 is composed of a photodiode and converts incident light from the subject photoelectrically into a signal charge.

The pixel unit 99 includes a readout transistor 2. The readout transistor 2 has a gate terminal 3 to which a transfer signal 10 is supplied. The readout transistor 2 reads the signal charge converted photoelectrically by the photoelectric conversion element 4 in accordance with the transfer signal 10 supplied to the gate terminal 3.

The pixel unit 99 includes an accumulation element 5. The accumulation element 5 is configured by floating diffusion and accumulates the signal charge read by the readout transistor 2.

The pixel unit 99 includes a detection transistor 6. The detection transistor 6 detects a voltage signal based on the signal charge accumulated in the accumulation element 5.

The pixel unit 99 includes a reset transistor 91. The reset transistor 91 supplies a reset potential to the accumulation element 5 in accordance with a reset signal 11 after the voltage signal is detected by the detection transistor 6 so that the signal charge is reset based on a VDDCELL signal 89.

The image pickup device 90 includes a digital signal processor (DSP) 97. The digital signal processor 97 includes a drive signal supplying portion 98. The drive signal supplying portion 98 supplies the VDDCELL signal 89, the reset signal 11, and the transfer signal 10 to each of the pixel units 99 of the pixel portion 96 of the imaging element 7.

The image pickup device 90 includes an analog-digital converter (ADC) 12. The analog-digital converter 12 converts the voltage signal detected by the detection transistor 6 in each of the pixel units 99 into a digital signal.

The digital signal processor 97 further includes an image processing circuit 13. The image processing circuit 13 produces a picture signal based on the digital signal converted by the analog-digital converter 12 and outputs the picture signal to the outside of the image pickup device 90.

The operation of the image pickup device 90 with the above configuration will be described below. FIG. 14 is a waveform diagram of the VDDCELL signal 89 that is supplied from the drive signal supplying portion 98 to the reset transistor 91 in each of the pixel units 99. FIG. 15 is a timing chart for explaining the operation of each of the pixel units 99 of the imaging element 7. FIG. 16(a) to 16(d) is a schematic diagram for explaining the movement of the signal charge in each of the pixel units 99 of the imaging element 7.

At time A, the photoelectric conversion element 4 converts incident light from a subject photoelectrically into a signal charge. Then, the transfer signal 10 to be supplied to the gate terminal 3 of the readout transistor 2 rises from the low state to the high state. Subsequently, at time B, the readout transistor 2 reads the signal charge converted photoelectrically by the photoelectric conversion element 4. The signal charge read by the readout transistor 2 is accumulated in the accumulation element 5.

Next, the transfer signal 10 to be supplied to the gate terminal 3 of the readout transistor 2 falls from the high state to the low state. Then, at time C, the detection transistor 6 detects a voltage signal based on the signal charge accumulated in the accumulation element 5.

Thereafter, the VDDCELL signal 89 falls from the high state to the low state, and the reset signal 11 to be supplied to the gate terminal of the reset transistor 91 rises from the low state to the high state. At time D, a charge flows into the accumulated element 5 through the reset transistor 91 based on the VDDCELL signal 89. Consequently, the potential of the accumulated element 5 is changed to the low state, thereby resetting the signal charge accumulated in the accumulation element 5.

However, the above configuration of the conventional image pickup device has the following disadvantages. As shown in FIG. 16(d), the charge flowing into the accumulated element 5 through the reset transistor 91 based on the VDDCELL signal 89 at time D may flow into the photoelectric conversion element 4 beyond the gate terminal 3 of the readout transistor 2. Therefore, when a picture signal is output after processing the voltage signal detected based on the signal charge that has been read from the photoelectric conversion element 4, a display image of the picture signal may cause white flaws, thus resulting in low image quality.

Therefore, with the foregoing in mind, it is an object of the present invention to provide an image pickup device that outputs a picture signal for displaying a high quality image.

### DISCLOSURE OF INVENTION

An image pickup device of the present invention includes an imaging element for imaging a subject and a drive signal supplying portion for supplying a drive signal to the imaging element so as to drive the imaging element. The imaging element includes a plurality of pixel units arranged in a matrix form. Each of the pixel units includes the following: a photoelectric conversion element for converting incident light from the subject to a signal charge; a readout transistor for reading the signal charge converted photoelectrically by the photoelectric conversion element; an accumulated element for accumulating the signal charge read by the readout transistor; a detection transistor for detecting a voltage signal based on the signal charge accumulated in the accumulated element; and a reset transistor for supplying a reset potential to the accumulated element based on the drive signal supplied by the drive signal supplying portion after the voltage signal is detected by the detection transistor so that the signal charge is reset. The readout transistor has a gate terminal to which a gate potential for reading the signal charge is supplied, and the read transistor reads the signal charge when the gate potential to be supplied to the gate terminal is changed from a first state to a second state. The detection transistor detects the voltage signal after the gate potential to be supplied to the gate terminal of the readout transistor is changed from the second state to the first state. The reset potential supplied from the reset transistor to the accumulated element has an intermediate potential between the gate potential in the first state that is supplied to the gate terminal of the readout transistor and a predetermined VDD potential.

### BRIEF DESCRIPTION OF DRAWINGS

FIG. 1 is a block diagram showing the configuration of an image pickup device according to Embodiment 1.

FIG. 2 is a schematic diagram showing the configuration of a pixel portion of an imaging element in the image pickup device according to Embodiment 1.

FIG. 3 is a circuit diagram showing the configuration of a pixel unit of the imaging element according to Embodiment 1.

FIG. 4 is a timing chart for explaining the operation of a pixel unit of the imaging element in the image pickup device according to Embodiment 1.

FIG. 5(a) to 5(d) is a schematic diagram for explaining the movement of a signal charge of a pixel unit of the imaging element in the image pickup device according to Embodiment 1.

FIG. 6 is a waveform diagram of an intermediate potential signal that is supplied from a drive signal supplying portion to a reset transistor in the image pickup device according to Embodiment 1.

FIG. 7 is a block diagram showing the configuration of an image pickup device according to Embodiment 2.

FIG. 8(a) is a waveform diagram of a synchronizing pulse that is supplied from an SSG to a driver in the image pickup device according to Embodiment 2.

FIG. 8(b) is a waveform diagram of an intermediate potential signal that is supplied from the driver to a reset transistor in the image pickup device according to Embodiment 2.

FIG. 9 is a block diagram showing the configuration of an image pickup device according to Embodiment 3.

FIG. 10(a) is a waveform diagram of a Hi-z signal that is supplied from an SSG to a bias circuit in the image pickup device according to Embodiment 3.

FIG. 10(b) is a waveform diagram of an intermediate potential signal that is supplied from the bias circuit to a reset transistor in the image pickup device according to Embodiment 3.

FIG. 11 is a block diagram showing the configuration of a conventional image pickup device.

FIG. 12 is a schematic diagram showing the configuration of a pixel portion of an imaging element of the conventional image pickup device.

FIG. 13 is a circuit diagram showing the configuration of a pixel unit of the conventional imaging element.

FIG. 14 is a waveform diagram of a drive signal that is supplied from a drive signal supplying portion to a reset transistor of the conventional image pickup device.

FIG. 15 is a timing chart for explaining the operation of a pixel unit of the imaging element of the conventional image pickup device.

FIG. 16(a) to 16(d) is a schematic diagram for explaining the movement of a signal charge in a pixel unit of the imaging element of the conventional image pickup device.

### DESCRIPTION OF THE INVENTION

In an image pickup device of the present invention, the reset potential supplied from the reset transistor to the accumulated element has an intermediate potential between the gate potential in the first state that is supplied to the gate terminal of the readout transistor and a predetermined VDD potential. Therefore, a difference between the reset potential and the gate potential in the first state can be sufficiently large. Thus, when the reset transistor supplies the reset potential to the accumulated element, the charge flowing from the reset transistor to the accumulated element is not allowed to flow into the photoelectric conversion element beyond the gate terminal of the readout transistor. Consequently, the image pickup device of the present invention can provide high image quality without causing white flaws due to the charge flowing into the photoelectric conversion element beyond the gate terminal of the readout transistor.

It is preferable that a difference between the reset potential and the gate potential in the first state is large enough to prevent a charge that flows from the reset transistor to the accumulated element from flowing into the photoelectric conversion element beyond the gate terminal of the readout transistor when the reset transistor supplies the reset potential to the accumulated element. This can suppress white flaws due to the charge flowing into the photoelectric conversion element beyond the gate terminal of the readout transistor.

It is preferable that the first state is a low state, and the second state is a high state. This allows the readout transistor to read the signal charge when the gate potential to be supplied to the gate terminal is changed from the low state to the high state.

It is preferable that the reset potential is higher than a ground potential and lower than the VDD potential. This can prevent the charge that flows from the reset transistor to the accumulated element from flowing into the photoelectric conversion element beyond the gate terminal of the readout transistor.

It is preferable that the gate potential in the first state is a ground potential. This allows the readout transistor to be controlled by the ground potential.

It is preferable that the reset transistor supplies the reset potential to the accumulated element in accordance with a predetermined pulse-shaped reset signal. This allows the reset transistor to control the timing of supplying the reset potential to the accumulated element.

It is preferable that the readout transistor reads the signal charge in accordance with a predetermined pulse-shaped transfer signal for supplying the gate potential to the gate terminal. This allows the readout transistor to control the timing of reading the signal charge from the photoelectric conversion element.

It is preferable that the drive signal supplying portion supplies a signal having the intermediate potential to each of the reset transistors. This allows each of the reset transistors to supply the reset potential having an intermediate voltage to the accumulated element.

It is preferable that the imaging element further includes a driver that produces a signal having the intermediate potential based on the drive signal supplied by the drive signal supplying portion and supplies the signal having the intermediate potential to each of the reset transistors. This can eliminate the need for providing a special circuit in the drive signal supplying portion to generate a signal having the intermediate potential.

It is preferable that the drive signal supplied by the drive signal supplying portion includes a Hi-z signal, and the imaging element further includes a bias circuit that produces a signal having the intermediate potential based on the Hi-z signal supplied by the drive signal supplying portion and supplies the signal having the intermediate potential to each of the reset transistors. This can eliminate the need for providing a special circuit in the drive signal supplying portion to generate a signal having the intermediate potential.

It is preferable that the image pickup device further includes an analog-digital converter for converting the voltage signal detected by each of the detection transistors of the imaging element into a digital signal, and an image processing circuit for outputting a picture signal based on the digital signal converted by the analog-digital converter. This configuration can provide a picture signal with high image quality.

Hereinafter, embodiments of the present invention will be described with reference to the drawings.

### Embodiment 1

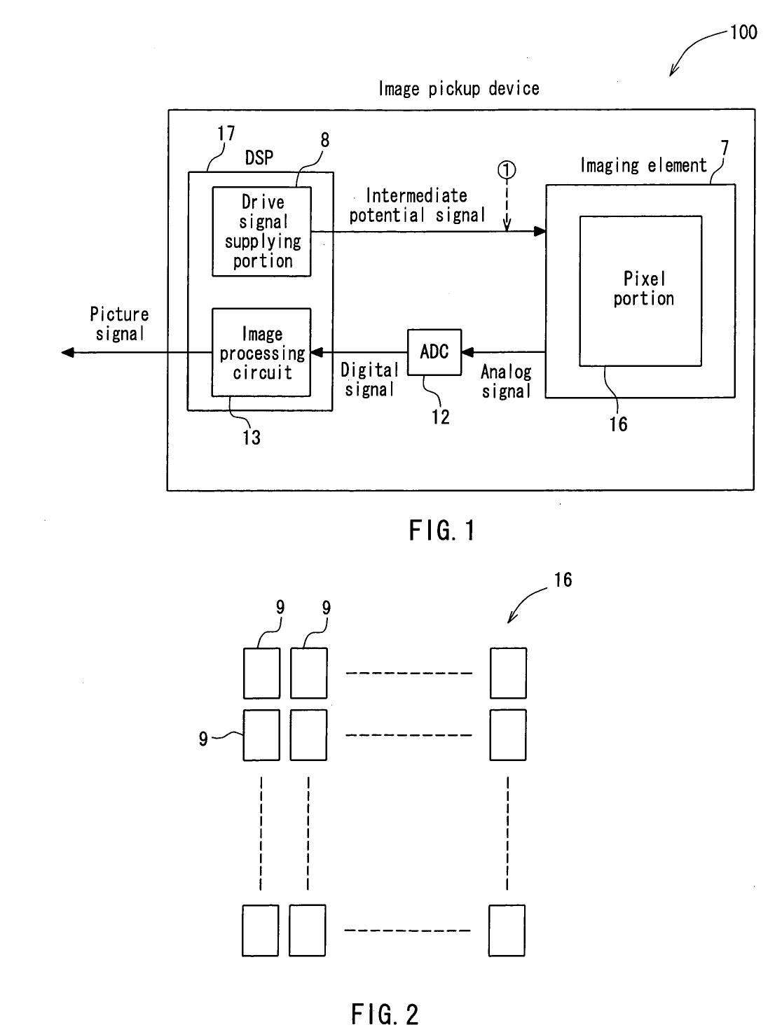

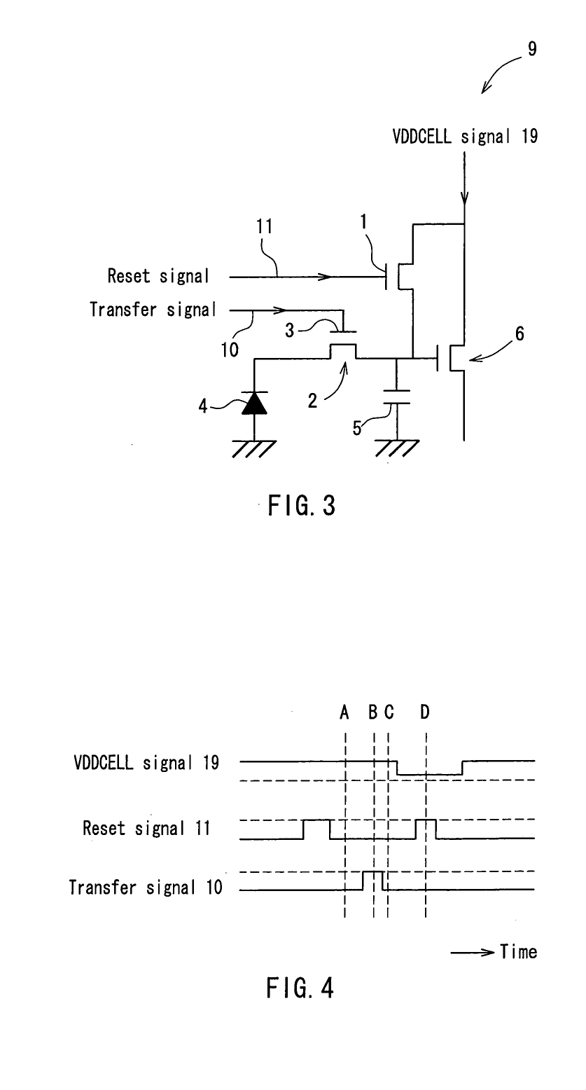

FIG. 1 is a block diagram showing the configuration of an image pickup device 100 of Embodiment 1. The image pickup device 100 includes an imaging element 7 for imaging of a subject. The imaging element 7 includes a pixel portion 16. FIG. 2 is a schematic diagram showing the configuration of the pixel portion 16. The pixel portion 16 has a plurality of pixel units 9 arranged in a matrix form. FIG. 3 is a circuit diagram showing the configuration of each of the pixel units 9. A pixel unit 9 includes a photoelectric conversion element 4. The photoelectric conversion element 4 is composed of a photodiode and converts incident light from the subject photoelectrically into a signal charge.

The pixel unit 9 includes a readout transistor 2. The readout transistor 2 has a gate terminal 3 to which a transfer signal 10 is supplied. The readout transistor 2 reads the signal charge converted photoelectrically by the photoelectric conversion element 4 in accordance with the transfer signal 10 supplied to the gate terminal 3.

The pixel unit 9 includes an accumulation element 5. The accumulation element 5 is configured by floating diffusion and accumulates the signal charge read by the readout transistor 2.

The pixel unit 9 includes a detection transistor 6. The detection transistor 6 detects a voltage signal based on the signal charge accumulated in the accumulation element 5.

The pixel unit 9 includes a reset transistor 1. The reset transistor 1 supplies a reset potential to the accumulation element 5 in accordance with a reset signal 11 after the voltage signal is detected by the detection transistor 6 so that the signal charge is reset based on a VDDCELL signal 19.

The image pickup device 100 includes a digital signal processor (DSP) 17. The digital signal processor 17 includes a drive signal supplying portion 8. The drive signal supplying portion 8 supplies the VDDCELL signal 19, the reset signal 11, and the transfer signal 10 to each of the pixel units 9 of the pixel portion 16 of the imaging element 7.

The image pickup device 100 includes an analog-digital converter (ADC) 12. The analog-digital converter 12 converts the voltage signal detected by the detection transistor 6 in each of the pixel units 9 into a digital signal.

The digital signal processor 17 further includes an image processing circuit 13. The image processing circuit 13 produces a picture signal based on the digital signal converted by the analog-digital converter 12 and outputs the picture signal to the outside of the image pickup device 100.

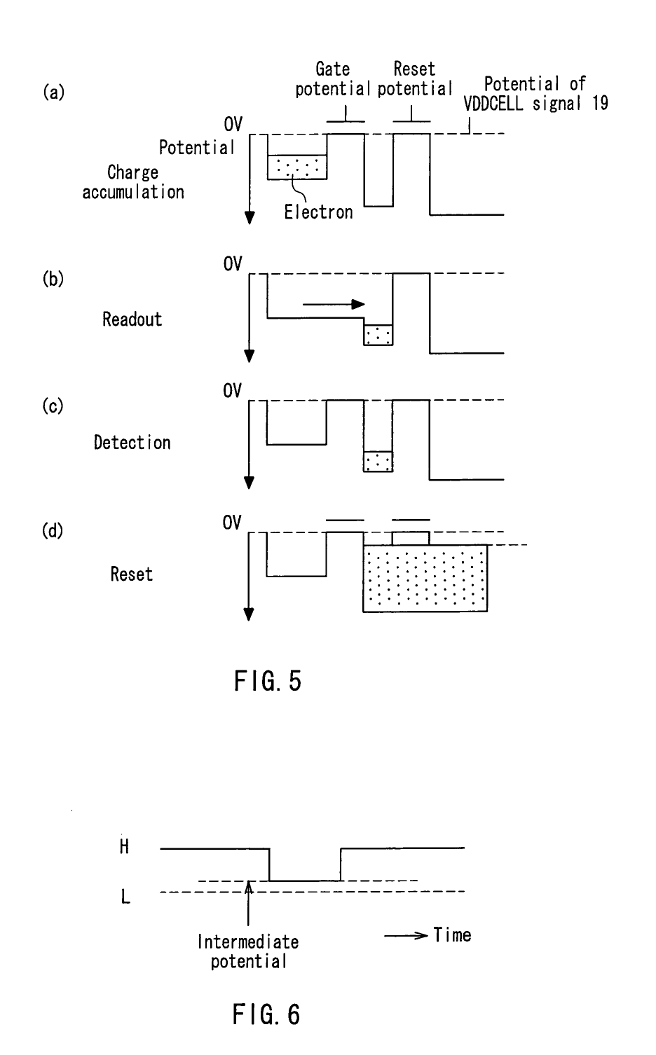

The operation of the image pickup device 100 with the above configuration will be described below. FIG. 4 is a timing chart for explaining the operation of each of the pixel units 9 of the imaging element 7. FIG. 5(a) to 5(d) is a schematic diagram for explaining the movement of the signal charge in each of the pixel units 9 of the imaging element 7. FIG. 6 is a waveform diagram of an intermediate potential signal that is supplied from the drive signal supplying portion 8 to the reset transistor 1.

At time A, the photoelectric conversion element 4 converts incident light from a subject photoelectrically into a signal charge. Then, the transfer signal 10 to be supplied to the gate terminal 3 of the readout transistor 2 rises from the low state to the high state. Subsequently, at time B, the readout transistor 2 reads the signal charge converted photoelectrically by the photoelectric conversion element 4. The high state of the gate terminal 3 may be, e.g., a VDD potential, and the low state may be, e.g., a ground potential. The signal charge read by the readout transistor 2 is accumulated in the accumulation element 5.

Next, the transfer signal 10 to be supplied to the gate terminal 3 of the readout transistor 2 falls from the high state to the low state. Then, at time C, the detection transistor 6 detects a voltage signal based on the signal charge accumulated in the accumulation element 5.

Thereafter, the VDDCELL signal 19 falls from the high state to the intermediate potential state between the high state and the low state, and the reset signal 11 to be supplied to the gate terminal of the reset transistor 1 rises from the low state to the high state. At time D, a charge flows into the accumulated element 5 through the reset transistor 1 based on the VDDCELL signal 19. Consequently, the potential of the accumulated element 5 is changed to the intermediate potential state between the high state and the low state, thereby resetting the signal charge accumulated in the accumulation element 5. The high state of the potential of the accumulated element 5 may be, e.g., a VDD potential, and the low state may. be, e.g., a ground potential.

At time D, the potential of the accumulated element 5 is in the intermediate potential state and is higher than the gate potential in the low state of the readout transistor 2. Such a potential difference between the accumulated element 5 and the readout transistor 2 is large enough to prevent the charge that flows from the reset transistor 1 to the accumulated element 5 from flowing into the photoelectric conversion element 4 beyond the gate terminal 3 of the readout transistor 2 when the reset transistor 1 supplies a reset potential to the accumulated element 5. Thus, the charge flowing from the reset transistor 91 to the accumulated element 5 is not allowed to flow into the photoelectric conversion element 4 beyond the gate terminal 3 of the readout transistor 2.

The ADC 12 converts the voltage signal detected by the detection transistor 6 into a digital signal. Then, the image processing circuit 13 processes the digital signal converted by the ADC 12, produces a picture signal, and outputs the picture signal to the outside of the image pickup device 100.

In Embodiment 1, the reset potential supplied from the reset transistor 1 to the accumulated element 5 has an intermediate potential between the VDD potential supplied to the gate terminal 3 of the readout transistor 2 and the ground potential. Therefore, a difference between the reset potential and the ground potential can be sufficiently large. Thus, when the reset transistor 1 supplies the reset potential to the accumulated element 5, the charge flowing from the reset transistor 1 to the accumulated element 5 is not allowed to flow into the photoelectric conversion element 4 beyond the gate terminal 3 of the readout transistor 2. Consequently, the image pickup device of this embodiment can provide high image quality without causing white flaws due to the charge flowing into the photoelectric conversion element 4 beyond the gate terminal 3 of the readout transistor 2.

### Embodiment 2

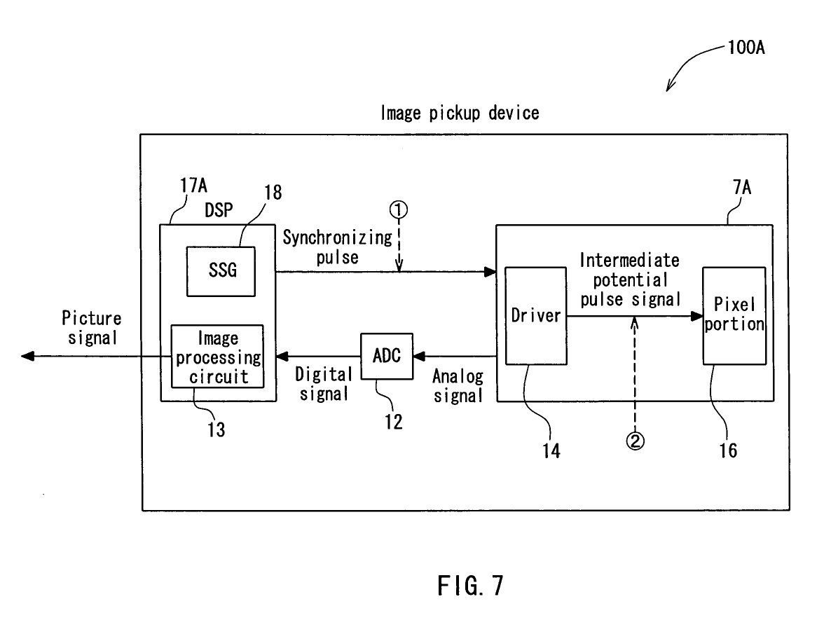

FIG. 7 is a block diagram showing the configuration of an image pickup device 100A of Embodiment 2. The identical elements to those of the image pickup device 100 in FIG. 1 of Embodiment 1 are denoted by the same reference numerals, and a detailed explanation will not be repeated. The image pickup device 100A differs from the image pickup device 100 of Embodiment 1 in that an imaging element 7A and a DSP 17A are used instead of the imaging element 7 and the DSP 17, respectively.

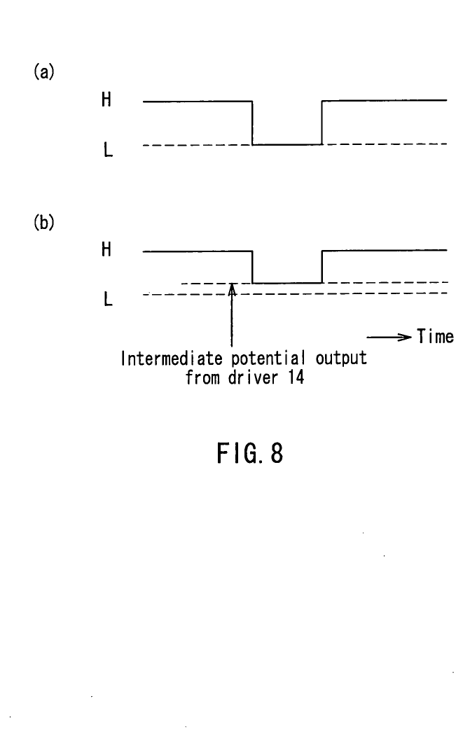

The DSP 17A includes an SSG 18. The SSG 18 produces a synchronizing pulse signal having high and low states, as shown in FIG. 8(a).

The imaging element 7A includes a driver 14. The driver 14 produces an intermediate potential pulse signal having a high state and an intermediate potential between the high state and the low state, as shown in FIG. 8(b), based on the synchronizing pulse signal produced by the SSG 18. Then, the driver 14 supplies the intermediate potential pulse signal to the reset transistor 1 in each of the pixel units 9.

The reset transistor 1 supplies a reset potential to the accumulated element 5 in accordance with the intermediate potential pulse signal supplied by the driver 14 so that the signal charge is reset.

In Embodiment 2, the driver 14 of the imaging element 7A produces the intermediate potential pulse signal based on the synchronizing pulse signal supplied by the SSG 18 and supplies it to each of the reset transistors 1. Therefore, it is not necessary to generate the intermediate potential pulse signal with an intermediate potential particularly from the SSG 18 of the DSP 17A. This can eliminate the need for providing a special circuit in the DSP to drive the NMOS imaging element.

### Embodiment 3

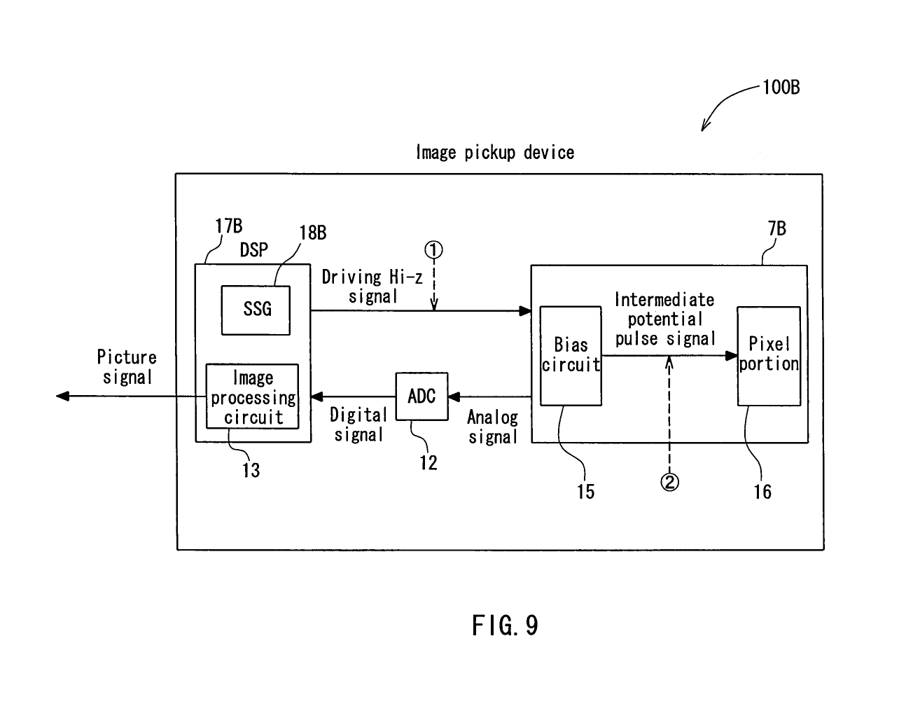

FIG. 9 is a block diagram showing the configuration of an image pickup device 100B of Embodiment 3. The identical elements to those of the image pickup device 100A in FIG. 7 of Embodiment 2 are denoted by the same reference numerals, and a detailed explanation will not be repeated. The image pickup device 100B differs from the image pickup device 100A of Embodiment 2 in that an imaging element 7B and a DSP 17B are used instead of the imaging element 7A and the DSP 17A, respectively.

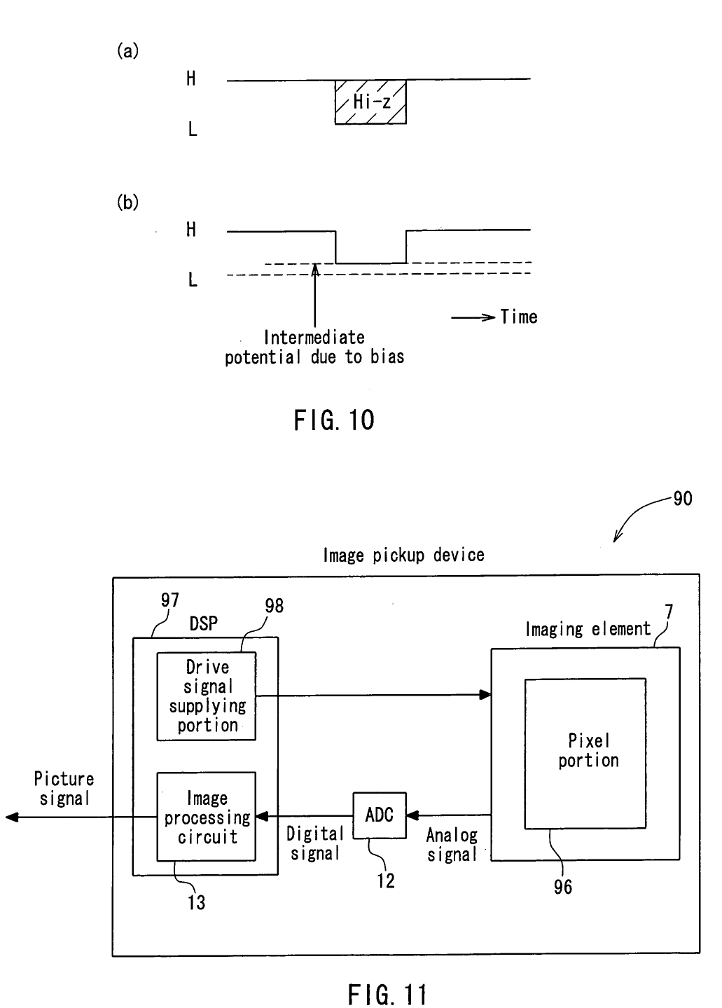

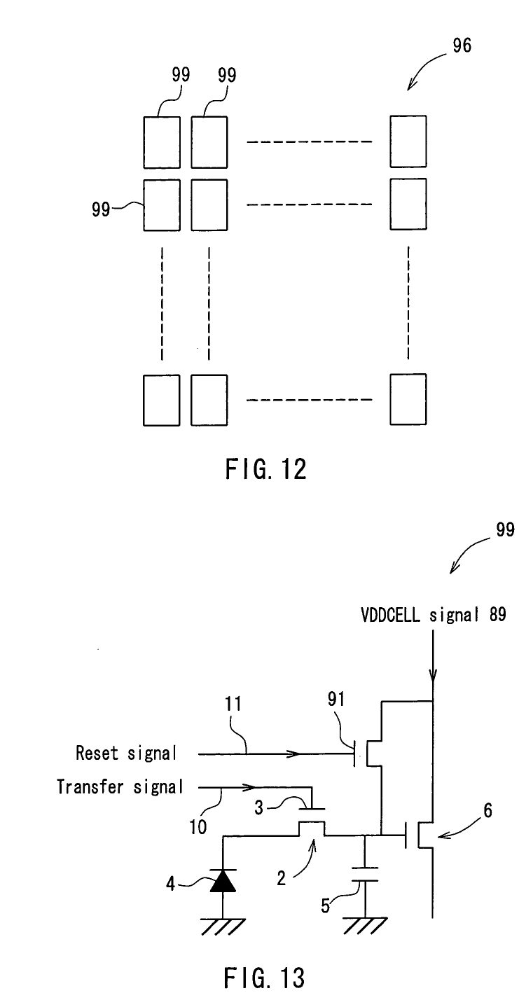

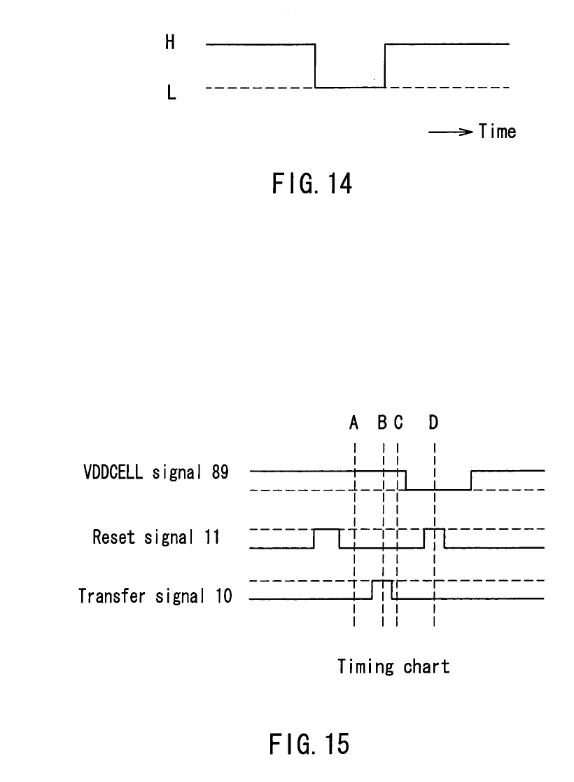

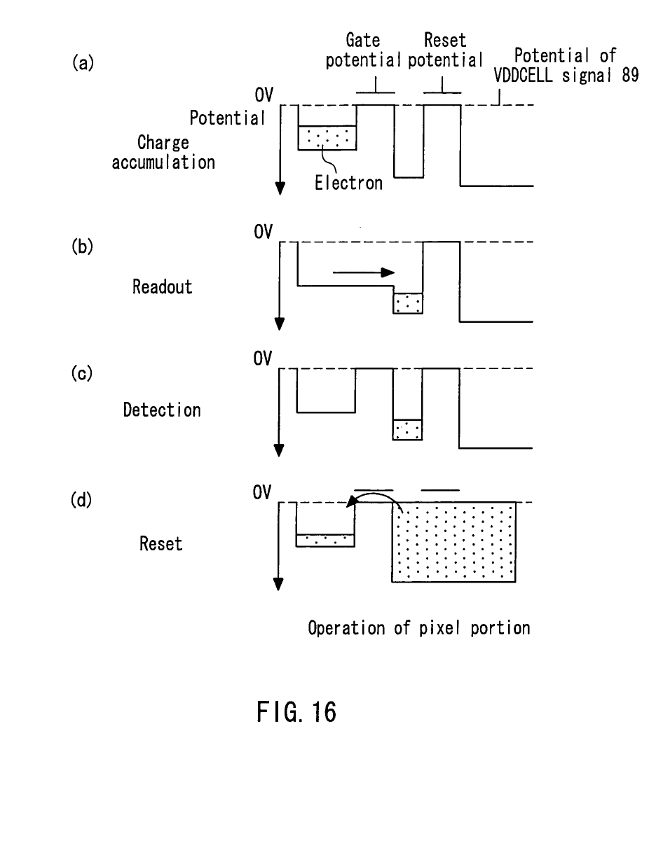

The DSP 17B includes an SSG 18B. The SSG 18B produces a driving Hi-z signal, as shown in FIG. 10(a). The driving Hi-z signal remains as a Hi-z signal during a predetermined period of time and becomes a high signal at a high level (VDD level) during the other period.

The imaging element 7B includes a bias circuit 15. Upon receiving the driving Hi-z signal from the SSG 18B, the bias circuit 15 produces an intermediate potential pulse signal having a high state and an intermediate potential between the high state and the low state during a predetermined period of time that the Hi-z signal is input, as shown in FIG. 10(b). Then, the bias circuit 15 supplies the intermediate potential pulse signal to the reset transistor 1 in each of the pixel units 9. While the high signal at a high level (VDD level) is input, the bias circuit 15 supplies the high signal at that level to the reset transistor 1.

The reset transistor 1 supplies a reset potential to the accumulated element 5 in accordance with the intermediate potential pulse signal supplied by the bias circuit 15 so that the signal charge is reset.

In Embodiment 3, the driving Hi-z signal supplied by the SSG 18B includes the Hi-z signal, and the bias circuit 15 of the imaging element 7B produces the intermediate potential pulse signal based on the Hi-z signal supplied by the SSG 18B and supplies it to each of the reset transistors 1. Therefore, like Embodiment 2, it is not necessary to generate the intermediate potential pulse signal with an intermediate potential particularly from the SSG of the DSP. This can eliminate the need for providing a special circuit in the DSP to drive the NMOS imaging element.

### INDUSTRIAL APPLICABILITY

As described above, the present invention can provide an image pickup device that outputs a picture signal for displaying a high quality image.

1. An image pickup device comprising:
an imaging element for imaging a subject; and
a drive signal supplying portion for supplying a drive signal to the imaging element so as to drive the imaging element;
wherein the imaging element comprises a plurality of pixel units arranged in a matrix form;
each of the pixel units comprises:
a photoelectric conversion element for converting incident light from the subject photoelectrically into a signal charge;
a readout transistor for reading the signal charge converted photoelectrically by the photoelectric conversion element;
an accumulated element for accumulating the signal charge read by the readout transistor;
a detection transistor for detecting a voltage signal based on the signal charge accumulated in the accumulated element; and
a reset transistor for supplying a reset potential to the accumulated element based on the drive signal supplied by the drive signal supplying portion after the voltage signal is detected by the detection transistor so that the signal charge is reset,
wherein the readout transistor has a gate terminal to which a gate potential for reading the signal charge is supplied, and the readout transistor reads the signal charge when the gate potential to be supplied to the gate terminal is changed from a first state to a second state,
wherein the detection transistor detects the voltage signal after the gate potential to be supplied to the gate terminal of the readout transistor is changed from the second state to the first state, and
wherein the reset potential supplied from the reset transistor to the accumulated element has an intermediate potential between the gate potential in the first state that is supplied to the gate terminal of the readout transistor and a predetermined VDD potential.

2. The image pickup device according to claim 1, wherein a difference between the reset potential and the gate potential in the first state is large enough to prevent a charge that flows from the reset transistor to the accumulated element from flowing into the photoelectric conversion element beyond the gate terminal of the readout transistor when the reset transistor supplies the reset potential to the accumulated element.

3. The image pickup device according to claim 1, wherein the first state is a low state, and the second state is a high state.

4. The image pickup device according to claim 1, wherein the reset potential is higher than a ground potential and lower than the VDD potential.

5. The image pickup device according to claim 1, wherein the gate potential in the first state is a ground potential.

6. The image pickup device according to claim 1, wherein the reset transistor supplies the reset potential to the accumulated element in accordance with a predetermined pulse-shaped reset signal.

7. The image pickup device according to claim 1, wherein the readout transistor reads the signal charge in accordance with a predetermined pulse-shaped transfer signal for supplying the gate potential to the gate terminal.

8. The image pickup device according to claim 1, wherein the drive signal supplying portion supplies a signal having the intermediate potential to each of the reset transistors.

9. The image pickup device according to claim 1, wherein the imaging element further comprises a driver that produces a signal having the intermediate potential based on the drive signal supplied by the drive signal supplying portion and supplies the signal having the intermediate potential to each of the reset transistors.

10. The image pickup device according to claim 1, wherein the drive signal supplied by the drive signal supplying portion includes a Hi-z signal, and
the imaging element further comprises a bias circuit that produces a signal having the intermediate potential based on the Hi-z signal supplied by the drive signal supplying portion and supplies the signal having the intermediate potential to each of the reset transistors.

11. The image pickup device according to claim 1, further comprising:
an analog-digital converter for converting the voltage signal detected by each of the detection transistors of the imaging element into a digital signal; and
an image processing circuit for outputting a picture signal based on the digital signal converted by the analog-digital converter.
